(19) United States
(12) Patent Application Publication
(10) Pub. No.: US 2009/0073307 A1
(43) Pub. Date: Mar. 19, 2009

(54) Digital image capture device and method

(76) Inventors: Marcus Kramer, San Diego, CA (US); Scott Valoff, San Diego, CA (US); Eric Gawehn, Mountain View, CA (US)

Correspondence Address: Haverstock & Owens- Cypress, 162 North Wolfe Road, Sunnyvale, CA, 94086, US

(21) Appl. No.: 12/283,701

(22) Filed: Sep. 12, 2008

Related U.S. Application Data
(60) Provisional application No. 60/972,674, filed on Sep. 14, 2007.

(51) Int. Cl. H04N 5/222

(52) U.S. Cl. 348/370; 348/E05.022

(57) ABSTRACT

A device for illuminating and capturing an image of an object can include a first light source mounted to structure; a second light source mounted to the structure; and an image sensor disposed adjacent to the first and second light sources and mounted to the structure. The image sensor may capture at least two different partial images of a target area, the partial images being captured under different acquisition conditions. A controller section may also include that has at least a memory that stores the at least two partial images to form a larger image.

This application claims the benefit of U.S. provisional patent application Ser. No. 60/972,674 filed on Sep. 14, 2007, the contents of which are incorporated by reference herein.

### TECHNICAL FIELD

The present disclosure relates to devices and methods for acquiring a digital image of a target object, and more particularly for methods and device having one or more light sources for illuminating a target object.

### BACKGROUND

Image capture devices, such as cameras, may often acquire unwanted glare or “hot spots” in a captured image due to the relative angle of the light source, the object being photographed, and the camera image sensor. Such glare is typically caused by the generation of a mirror image of an actual source of light used to illuminate the object being imaged, and may arise from the direct versus indirect light rays emanating from the light source. Objects having a smooth, shiny, or reflective surface typically cause the most glare.

Glare in an acquired image may be undesirable as it can tend to wash out portions of the image due to overexposure relative to the rest of the image.

The artificial light source may be located in a position where the angle of the direct light rays do not reflect directly into a lens of a camera acquiring the image. However, in many cases, there are constraints on the position of a light source relative to a camera and the object being photographed, which may make elimination of glare difficult or not possible in conventional arrangements. Further, in arrangements where light sources may be situated a relatively large distance away from an image sensor, a resulting image may have undesirable shadows (for objects having three dimensional features). This may hamper image processing.

### BRIEF DESCRIPTION OF THE DRAWINGS

FIG. 1 is a side cross sectional view of a device according to one embodiment.

FIG. 2 is a block schematic diagram of a device according to another embodiment.

FIG. 3 is a representation of image portions that may be acquired by a device like that shown in FIGS. 1 and/or 2.

FIGS. 4A to 4F are diagrams showing devices and methods according to further embodiments.

FIGS. 5A to 5E are diagrams showing devices and methods according to additional embodiments.

FIGS. 6A to 6F are diagrams showing devices and methods according to other embodiments.

FIGS. 7A to 7E are diagrams showing devices and methods according to more embodiments.

FIGS. 8A to 8D are diagrams showing devices and methods according to additional embodiments.

FIGS. 9A to 9D are side cross sectional views showing another embodiment.

FIGS. 10A to 10C are diagrams showing additional embodiments.

FIGS. 11A and 11B are a side cross sectional view and plan view of a device according to an embodiment.

FIGS. 12A and 12B are a side cross sectional and a plan view of a device according to an embodiment.

FIGS. 13A and 13B are a side cross sectional view and a plan view of a device according to an embodiment.

FIGS. 14A and 14B are a side cross sectional and a plan view of a device according to an embodiment.

FIGS. 15A to 15E are diagrams showing various other embodiments.

### DETAILED DESCRIPTION

Various embodiments will now be described that show devices and methods for capturing a digital image of a target object. In particular embodiments, different portions of a same image may be acquired under different conditions and then assembled together to create a final image that may not suffer from undesirable glare present in conventional approaches.

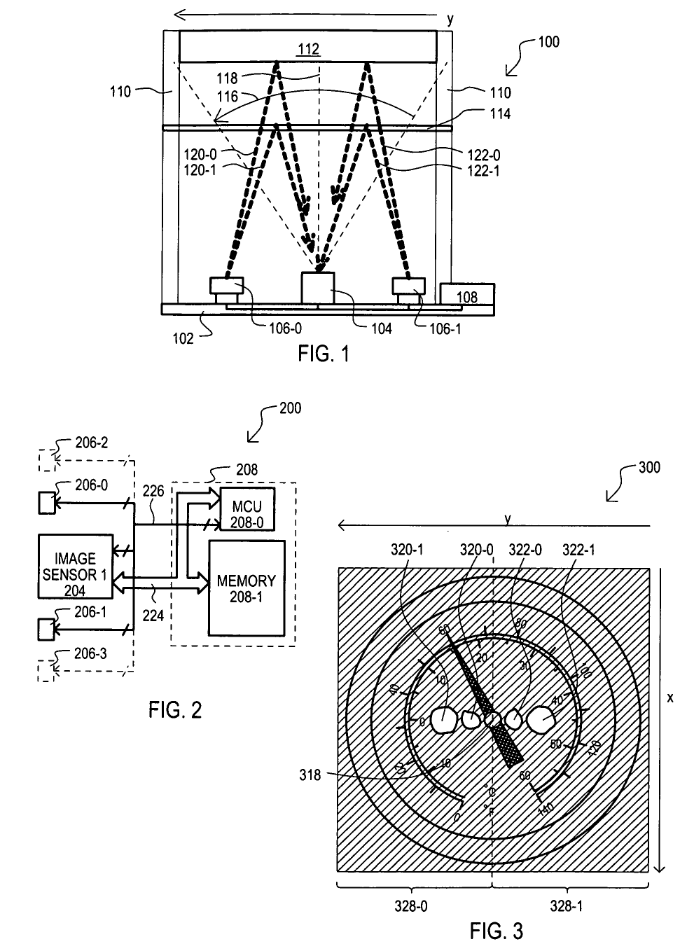

Referring to FIG. 1, a device for illuminating and capturing an image of a target object is shown in a side view and designated by the general reference character 100. A device 100 may include a structure 102, an image sensor 104, multiple light sources (in this particular example, two light sources 106-0 and 106-1), and a control section 108. A structure 102 may provide one or more surfaces to which various components, including image sensor 104, light sources (106-0 and 106-1), and/or control section 108 may be attached. In particular arrangements, a structure 102 may include one or more circuit boards that provide conductive connections between the various components. However, while FIG. 1 shows image sensor 104 and light sources (106-0 and 106-1) attached to a same planar surface, as will be shown in other embodiments, and understood from the variety of embodiments shown herein, such components may be positioned in a non-coplanar fashion with respect to one another.

Optionally, a structure 102 may include attaching portions 110, that may enable device 100 to be physically attached to an imaged object 112 (object for which an image is to be taken). Even more particularly, in very particular arrangements, structure 102 may be an enclosing structure with respect to object 112, preventing light from entering an interior of the structure 102, and thus making light sources (106-0 and 106-1) the source of illumination for an image capture. In addition or alternatively, a structure 102 may optionally include a transparent window structure 114 disposed between image sensor 104 and object 112.

An image sensor 104 may acquire a digital image of object. Such an image may be divisible into one or more image portions. In the embodiment of FIG. 1, when an image sensor 104 is attached to structure 102, it may be conceptualized as having a field of capture 116 that indicates the extents of a captured image. Such a field of capture 116 may be centered about an imaginary axis 118. It is understood that a field of capture 116 may have a shape dictated by an aperture, lens, or sensing array (or combinations thereof) of image sensor 104. In very particular embodiments, an image sensor 104 may include an integrated circuit device, such as a CMOS image sensor or a CCD image sensor. Further, such an integrated circuit may be mounted below an aperture and/or lens to provide a desired field of focus and/or range of focus.

Light sources (106-0 and 106-1) may provide illumination utilized in capturing an image of target 112. Light sources (106-0 and 106-1) may be independently controllable, to enable one light source (e.g., 106-0 or 106-1) to be emitting light, while another light source (e.g., 106-1 or 106-0) is not emitting light. In very particular arrangements, light sources may be light emitting diodes (LEDs).

A control section 108 may provide signals for controlling the operation of image sensor 104 and/or light sources (106-0 and 106-1). A control section 108 may be integrated with any other components (e.g., 104), but is shown separate in the embodiment of FIG. 1. In such an arrangement, a control section 108 may provide controls signals for separately activating and deactivating light sources (106-0 and 106-1) and/or for initiating one or more image capture operations for image sensor 104. A control section 108 may also provide configuration information for image sensor 104 to enable particular features of an image capture operations. A control section 108 may be situated at various other locations within device 100, and the particular location shown in FIG. 1 is but an example.

Referring still to FIG.1, activation of either light source (106-0 and 106-1) may cause reflections of such light sources to generate glare. Such glare is represented by arrows 120-0/1 and 122-0/1. More particularly, arrow 120-0 may represent a light ray generated by light source 106-0 reflecting off object 112, while arrow 120-1 may represent a light ray from light source 106-0 reflecting off transparent window structure 114. Similarly, arrows 122-0 and 122-1 may represent a light ray from light source 106-1 reflecting off object 112 and transparent window structure 114, respectively.

In this way, a device may include multiple, separately controllable light sources as well as an image sensor.

Referring now to FIG. 2, a device according to another embodiment is shown in a block schematic diagram and designated by the general reference character 200. A device 200 may include some of the same items and FIG. 1, thus like items are referred to by the same reference character but with the first digit being a “2” instead of a “1”. In one particular arrangement, device 200 may be one example of device 100 shown in FIG. 1.

Referring still to FIG. 2, in the embodiment shown, a control section 208 may include a microcontroller (MCU) 208-0 as well as memory 208-1. An MCU 208-0 may include a processor for executing instructions that may be stored in dedicated processor memory, or in memory 208-1. In response to such instructions, an MCU 208-0 may generate control signals on control signal paths 226 to separately control the operation of light sources (at least 206-0 and 206-1) and image sensor 204. The embodiment of FIG. 2 also shows an address/data bus 224 that may allow image sensor 204 and MCU 208-0 to access memory 208-1. It is understood that MCU 208-0 could access memory 208-1 via a bus separate from that utilized by image sensor 204. Still further such address/data buses may allow for the transfer of data in a serial, and/or parallel fashion.

An image sensor 204 may transfer image data to memory 208-1. Such a transfer may involve an entire image, or a portion of an image.

FIG. 2 shows additional light sources 206-2 and 206-3 to demonstrate that alternate embodiments may include more than two light sources.

In this way, a device may include an image sensor, separately controllable light sources and a memory for storing one or more images capture by an image sensor.

Referring to FIG. 3, a representation of an image that may be captured by a device like that of FIGS. 1 and/or 2 is shown in a diagram. FIG. 3 shows an image 300 of a deflection type needle gauge. Such an image 300 may have an orientation with respect to light sources and an image sensor. More particularly, FIG. 1 shows a direction “y” by an arrow. A corresponding direction in image 300 is also shown by an arrow designated “y”. In addition, a particular position of axis 118 is shown as 318 in FIG. 3.

From such an orientation, light sources 106-0 and 106-1 may be conceptualized as being disposed in the “y” direction (which may also be described as a “horizontal” direction with respect to a resulting image). However, alternate embodiments may include light sources arranged in various other orientations, such as in an “x” direction (perpendicular to the y direction), or diagonal directions, to name but two.

An image 300 may include multiple portions that may each be acquired under different conditions, to thereby address unwanted glare effects. In the example shown, image 300 may include a first portion 328-0 and a second portion 328-1. As shown, a first portion 328-0 may include “hot spots” 320-0 and 320-1, which may include reflections indicated by arrows 120-0 and 120-1, respectively, in FIG. 1. In the same fashion, a second portion 328-1 may include “hot spots” 322-0 and 322-1, which may include reflections indicated by arrows 122-0 and 122-1, respectively, in FIG. 1.

In this way, a device may acquire an image in which glare from one light source may adversely effect a first image portion and not a second image portion, while glare from another light source may adversely affect the second image portion and not the first image portion.

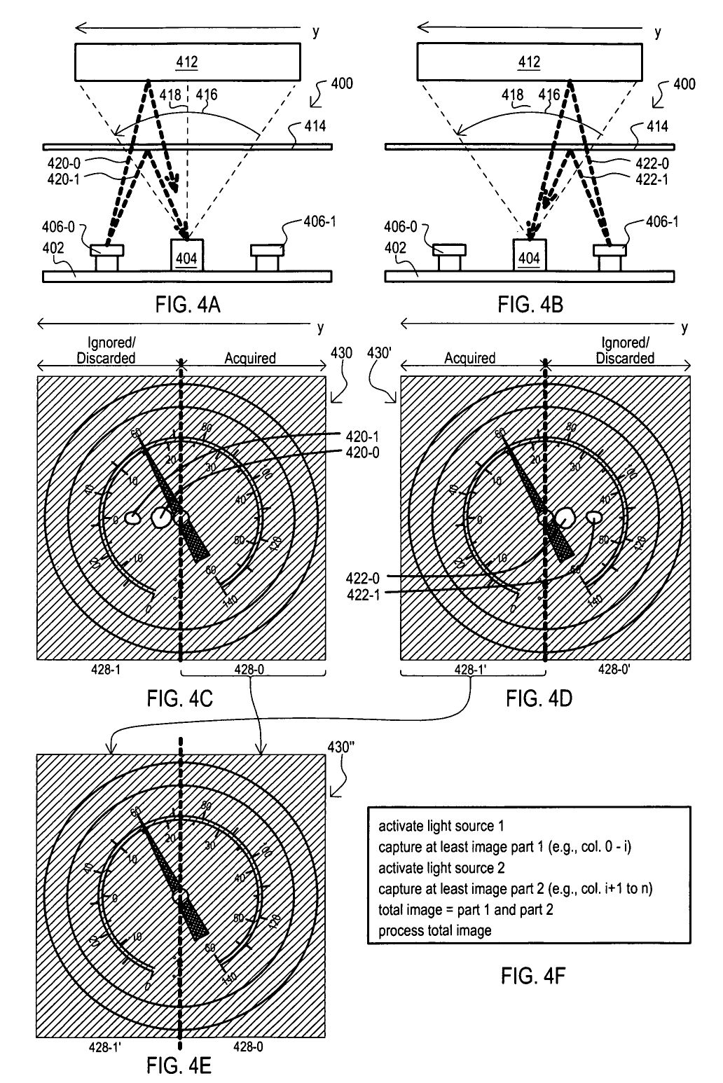

Referring to FIGS. 4A to 4F, a device and method according to another embodiment is shown in a series of diagrams. FIGS. 4A to 4F show an arrangement in which two different portions of an image may be captured under different lighting conditions and then joined (i.e., stitched) together to form a final image. In the particular example shown, the different portions may be free of unwanted glare effects.

FIGS. 4A and 4B are diagrams showing two different operations of a device 400 according to an embodiment. A device 400 may include some or all of the items as device 100 of FIG. 1, thus like features are shown with the same reference characters but with the first digit being a “4” instead of a “1”. In one arrangement, device 400 may be one version of that shown in FIG. 1 or FIG. 2.

Referring to FIG. 4A, in a first operation, a device 400 may activate first light source 406-0 while second light source 406-1 remains deactivated. Under such conditions, an image sensor 404 may be operated to acquire at least a first image portion of a target object 412, which in this particular example is once again a deflection type needle gauge. FIG. 4C shows one particular example of image data that may be captured by such an operation.

Referring to FIG. 4C, image data 430 captured in an operation like that of FIG. 4A may capture at least a first image portion 428-0. It is noted that such an image portion 428-0 may be free of glare effects (420-0 and 420-1) from activated first light source 406-0. Optionally, an operation may capture a second image portion 428-1 that may include glare effects (420-0 and 420-1). However, if such a second image portion 428-1 is captured, it may be discarded or ignored in a subsequent image “stitching” operation, as will be described in more detail below.

Referring to FIG. 4B, in a second operation, a device 400 may activate second light source 406-1 while first light source 406-0 is deactivated. Under such conditions, an image sensor 404 may be operated to acquire at least a second image portion of a target object 412. FIG. 4D shows one particular example of image data that may be captured by such an operation.

Referring to FIG. 4D, image data 430′ captured in an operation like that of FIG. 4B may capture at least a second image portion 428-1′. It is noted that such an image portion 428-1′ may be free of glare effects (422-0 and 422-1) arising from activated second light source 406-1. Like the operation shown by FIG. 4C, optionally, an operation may capture a first image portion 428-0′ that may include glare effects (422-0 and 422-1). However, if such a first image portion 428-0′ is captured, it too may be discarded/ignored in a subsequent image “stitching” operation.

Referring to FIG. 4E, a “stitched” image 430″ may be created by combining a first image portion 428-0 acquired as shown in FIG. 4C, with a second image portion 428-1′ acquired as shown in FIG. 4D. Such a stitched image 430″ may be free of glare effects. Image 430″ may then be processed, for example, to generate a digital value reading of the gauge.

A stitched image 430″ may be created in a number of ways. As but one example, in a first acquisition operation, an image sensor 404 may store a first image having a glare effect (e.g., all of 430 or 430′). In a second acquisition operation, an image sensor may acquire, all of an image, or a portion of the image not having glare, and overwrite the previous image data locations having a glare effect (e.g., 428-1 overwritten with 428-1′ or 428-0′ overwritten with 428-0). Alternatively, both images (all of 430 and all of 430′) may be fully captured under the different lighting conditions. Glare free portions of such images (428-0 and 428-1′) may then be read out in an image processing operation, or stored at another location.

Referring to FIG. 4F, another embodiment is shown in a diagram. FIG. 4F may show a method according to an embodiment. Alternatively, FIG. 4F may represent a pseudocode version of instructions executable by a control section, like that shown as 208 in FIG. 2.

As shown in FIG. 4F, a first light source (light source 1) may be activated. Such an action may not create glare in a first portion (part 1) of an image, while creating glare in another portion (part 2). At least a first portion (part 1) of an image may then be captured. In the particular example shown, this may include an image sensor having pixels arranged into columns, and only acquiring a particular contiguous group of columns (columns 0 to i). Of course, depending upon image sensor orientation, and information known about the glare, numerous other ways of partitioning an image may be utilized, including but not limited to: dividing according to consecutive rows, according to rectangular areas defined by row/column coordinates, according to diagonal rows, according to concentric circles, according to radial sweeps, to name but a few.

Referring still to FIG. 4F, the same general approach may then be performed on a second portion of an image. A second light source (light source 2) may be activated. Such an action may not create glare in a second portion (part 2) of an image, while creating glare in the first portion (part 1). At least a second portion (part 2) of an image may then be captured. In the particular example shown, this may include an image sensor having pixels arranged into columns, and only acquiring a particular contiguous group of columns (columns i+1 to n).

A total image may then be formed by combining at least the first and second image portions (total image=part 1 and part 2), thus creating an image that does not include unwanted glare effects, for example. Such a total image may then be processed. As but one example, such processing may generate a reading value from the image.

In this way, a device may have two different image acquisition operations to acquire two different image portions under different acquisition conditions to create different images portions without undesirable glare, for example. Such image portions may then be combined to create an image without undesirable glare, for example.

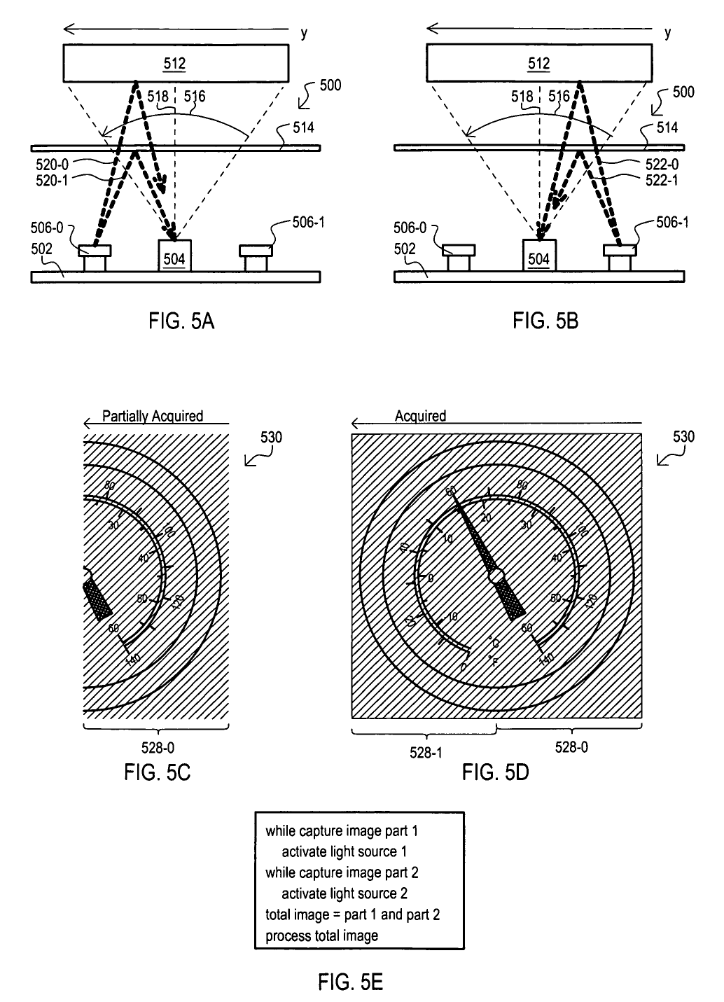

Referring now to FIGS. 5A to 5E, a device and method according to other embodiments are shown in a series of diagrams. FIGS. 5A to 5E show an arrangement in which two different portions of an image may be captured in a single acquisition operation. Thus, two different image portions do not have to be joined.

FIGS. 5A and 5B are diagrams showing two different actions of a device 500 in a same image acquisition operation. A device 500 may include some or all of the items of device 100 of FIG. 1, thus like features are shown with the same reference characters but with the first digit being a “5” instead of a “1”. In one arrangement, device 500 may be one version of that shown in FIG. 1 or 2.

Referring to FIG. 5A, in a first part of an operation, a device 500 may activate first light source 506-0 while second light source 506-1 remains deactivated. At the same time, an image sensor 504 may be operated to acquire a first image portion 528-0, which in this particular example, is again a deflection type needle gauge. FIG. 5C is a representation of an image captured by an image sensor 504 at this point in the operation.

Referring to FIG. 5C, image data 530 may initially include first image portion 528-0. It is noted that such an image portion 528-0 may be free of glare effects (520-0 and 520-1) from activated first light source 506-0.

Referring to FIG. 5B, in the same acquisition operation, a device 500 may activate second light source 506-1 and deactivate a first light source 506-0. At the same time, image sensor 504 may continue and acquire second image portion 528-1, and thus complete (in this example) the acquired image. FIG. 5D is a representation of the acquired image 530 after the acquisition operation.

Referring to FIG. 5D, image data 530 captured includes first image portion 528-0 and second image portion 528-1. As shown, image data 530 may be free of glare effects.

An operation like that shown in FIGS. 5A to 5D may include utilizing an image sensor, such as a CMOS type image sensor, that includes a “rolling shutter” type feature. A device with a rolling shutter may sequentially enable columns (or rows) of image sensing cells. Thus, in utilizing such a rolling shutter, a first light source (e.g., 506-0) may initially be enabled as a rolling shutter acquires a first portion of an image (e.g., first set of columns). A first light source (e.g., 506-0) may then be disabled and a second light source (e.g., 506-1) may be enabled as the rolling shutter continues to acquire a further portion of the image. It is noted that for many image sensor integrated circuits, color filtering features may be built-in (e.g., image sensor cells have a “Bayer” pattern arrangement). This can make filtering possible with a single image acquisition, as noted above, for lower power consumption (versus multiple images and stitching). Further, no additional physical filters are used.

Referring to FIG. 5E, another embodiment is shown in a diagram. FIG. 5E may show a method according to an embodiment, or alternatively, a pseudocode version of instructions executable by a control section, like that shown as 208 in FIG. 2.

As shown in FIG. 5E, while a first portion of an image (part 1) is being captured, a first light source (light source 1) may be activated. While a second portion of the image (part 2) is being captured, a second light source (light source 2) may be activated. As in the case of FIG. 4F, a resulting total image may be free of unwanted glare effects. Such a total image may then be processed.

In this way, a device may have one image acquisition operation that changes conditions as different portions of a single image are being captured. Such changes in conditions may prevent unwanted glare from being introduced into each portion, thus producing a single image without undesirable glare.

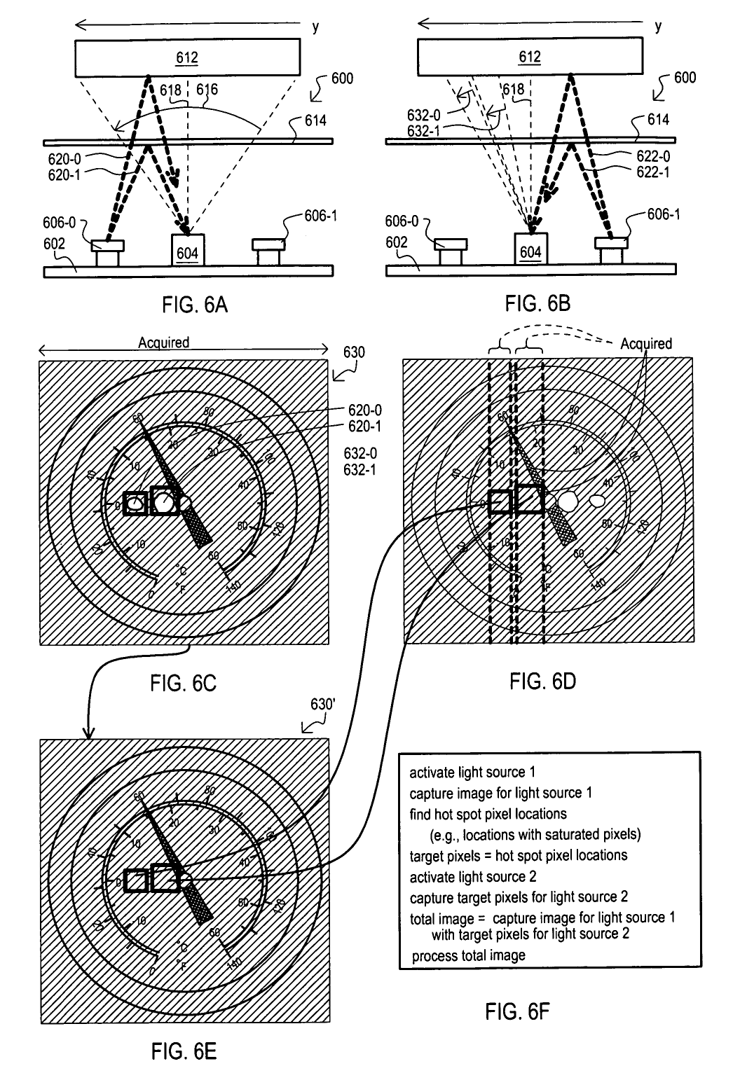

Referring now to FIGS. 6A to 6F, a device and method according to another embodiment is shown in a series of diagrams. FIGS. 6A to 6F show an arrangement in which undesirable sections of a first image may be determined, and then replaced by corresponding sections of a second image taken under different conditions. In the particular example shown, image sections containing unwanted glare may be detected and replaced by corresponding portions of another image without such unwanted glare.

FIGS. 6A and 6B are diagrams showing two different operations of a device 600 according to an embodiment. A device 600 may include some or all of the items of device 100 of FIG. 1, thus like features are shown with the same reference characters but with the first digit being a “6” instead of a “1”. In one arrangement, device 600 may be one version of that shown in FIG. 1 or FIG. 2.

Referring to FIG. 6A, in a first operation, a device 600 may activate first light source 606-0 while second light source 606-1 remains deactivated. Under such conditions, an image sensor 604 may be operated to acquire a first image of a target object 612.

FIG. 6C is a representation of image data 630 that may be captured in an operation like that of FIG. 6A. Image data 630 may include glare effects (620-0 and 620-1) from activated first light source 606-0. Such glare effects (“hot spots” 620-0 and 620-1) may then be detected. As but one example, pixel data can be examined to determine if it represents hot spot data. In one example, hot spot data may be determined by finding the position of fully saturated pixels. However, alternate arrangements may include intensity threshold levels for one or more color spectrums.

Once hot spot image locations have been determined, a second operation may be performed to capture image data under different conditions to replace the hot spot locations in the first image.

Referring to FIG. 6B, in a second operation, a device 600 may activate second light source 606-1 while first light source 606-0 is deactivated. Under such conditions, an image sensor 604 may be operated to acquire data for those locations that contained hot spots in the first operation. FIG. 6D shows one representation of image data that may be captured by such an operation. Such a limited field of capture is shown by 632-0 and 632-1.

Referring to FIG. 6D, in a second operation, image sensor 604 may capture partial fields 632-0 and 632-1, corresponding to hot spot locations. In FIG. 6D, such partial fields are shown superimposed on what would be a full field of capture (e.g., field captured in previous operation). While partial fields (632-0 and 632-1) are shown to have rectangular shapes, other configurations may have other shapes. As but one example, a partial field could include columns (or rows) as indicated by dashed lines in FIG. 6D. Alternatively, partial fields may be a collection of pixels having irregular sides and/or that are not contiguous with one another. Partial fields (632-0 and 632-1) may be free of glare effects arising from activated second light source 606-1.

Referring to FIG. 6E, a “stitched” image 630′ may be created by replacing hot spot locations from first image data 630 with partial field capture data (632-0 and 632-1) acquired at the same locations, but under different conditions (in this case lighting conditions). As shown, such an image data 630′ may be free of glare effects. Image 630′ may then be processed, for example, to generate a digital value reading of the gauge.

Referring to FIG. 6E, a further embodiment is shown in a diagram. FIG. 6E may show a method according to an embodiment. Alternatively, FIG. 6E may represent a pseudocode version of instructions executable by a control section, like that shown as 208 in FIG. 2.

As shown in FIG. 6E, a first light source (light source 1) may be activated. Such a step may create glare in one portion of a first image. Those locations containing such glare may be located (e.g., saturated pixels). Locations containing glare may be designated target pixels. A second light source (light source 2) may then be activated, and data for the target pixels may be acquired. An image (total image) may then be created by combining the first image and target pixels. Such a total image may then be processed.

In this way, a device may have two different image acquisition operations to acquire a first image portion under first acquisition conditions to determine undesired image locations, for example. Under second conditions, image data for such undesired locations may be acquired. Data for locations acquired under second conditions may be substituted for corresponding locations in the first image to create an overall image without the undesired image data.

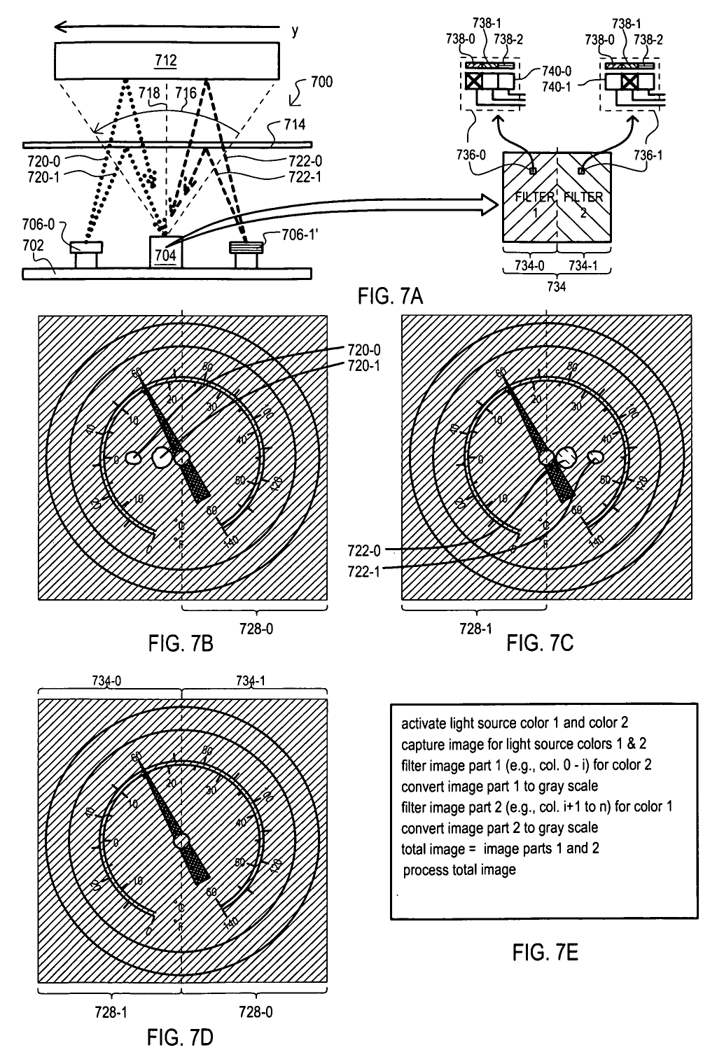

Referring to FIGS. 7A to 7F, a device and method according to further embodiments are shown in a series of diagrams. FIGS. 7A to 7F show an arrangement in which two different portions of an image may be captured under different light filtering conditions to form a final image that may be free of unwanted glare effects.

FIG. 7A shows an operation of a device 700 according to an embodiment. A device 700 may include some or all of the items as device 100 of FIG. 1, thus like features are shown with the same reference characters but with the first digit being a “7” instead of a “1”. In one arrangement, device 700 may be one version of that shown in FIG. 1 or FIG. 2.

In the particular embodiment of FIG. 7A, light source 706-0 may emit a different spectrum of light than light source 706-1′. In addition, an image sensor 704 may have light filtering capabilities that may separately filter different portions of a captured image. Thus, in FIG. 7A, image sensor 704 may include an image sensor array 734 divisible into multiple portions (in this example to portions 734-0 and 734-1). Each such portion (734-0 and 734-1) may be configured to filter out different light spectrums. Each array portion (734-0 and 734-1) may include cell sensors, two shown as 736-0 and 736-1.

FIG. 7A shows but one possible example of how such cells may be configured for different color filtering. Each cell (736-0 and 736-1) may include multiple color filters 738-0 to 738-2 that may each filter incident light differently. Cell sensors 740-0 and 740-1 can each selectively capture light from a different filter. A sensor corresponding to a particular filter may be disabled to acquire light in a filtered fashion. In the example shown, in sensor cell 736-0 a sensor corresponding to filter 738-0 may be disabled, while in sensor cell 736-1, a sensor corresponding to filter 738-1 may be disabled.

Referring to FIG. 7A, in an image capture operation, a device 700 may activate both first light source 706-0 and second light source 706-1′. An image sensor 704 may be operated to acquire at an image of a target object 712. However, image sensor 704 may be configured as noted above, to filter out different light spectra between different portions of an image. More particularly, where an image sensor 704 would detect a hot spot due to first light source 706-0 (corresponding to rays 720-0 and 720-1), the image sensor 704 may filter out such a light color, and hence filter out such a hot spot. Similarly, where an image sensor 704 would detect a hot spot due to second light source 706-1′ (corresponding to rays 722-0 and 722-1), the image sensor 704 may filter out such a light color, and hence filter out such a differently colored hot spot.

FIG. 7B is a representation of how an image would be captured were an image sensor configured to just filter out light generated from second light source 706-1′. In such an arrangement, image portion 728-0 would have glare filtered out.

FIG. 7C is a representation of how an image would be captured were an image sensor configured to just filter out light generated from first light source 706-0. In such an arrangement, image portion 728-1 would have glare filtered out.

FIG. 7D is a representation of an image acquired according to an embodiment is shown. Image portion 728-0 is filtered as in FIG. 7B, while image portion 728-1 is filtered as in FIG. 7C. As a result, unwanted glare may be filtered out from both image portions. In one arrangement, image data may be converted to a common intensity format (e.g., gray scale) prior to being processed.

Referring to FIG. 7E, a further embodiment is shown in a diagram. FIG. 7E may show a method according to an embodiment. Alternatively, FIG. 7E may represent a pseudocode version of instructions executable by a control section, like that shown as 208 in FIG. 2.

As shown in FIG. 7E, light sources for two colors (color 1 and color 2) may be activated. Such a step may create glare of different color types in different portions of an image. Under such conditions, an image may be captured. However, one image portion (part 1) containing glare of a particular color (color 2) may be filtered for the glare of that color. In the particular example, the image portion (part 1) may also be converted to gray scale. Similarly, another image portion (part 2) containing glare of a particular color (color 1) may be filtered for the glare of that color. In the particular example, the image portion (part 2) may also be converted to gray scale. The resulting gray scale image may then be processed.

In this way, a device may acquire an image with two or more different illumination colors. As the image is being acquired, different portions of the image may be filtered differently to remove glare of a particular color. Consequently, the acquired image may be free of undesirable glare.

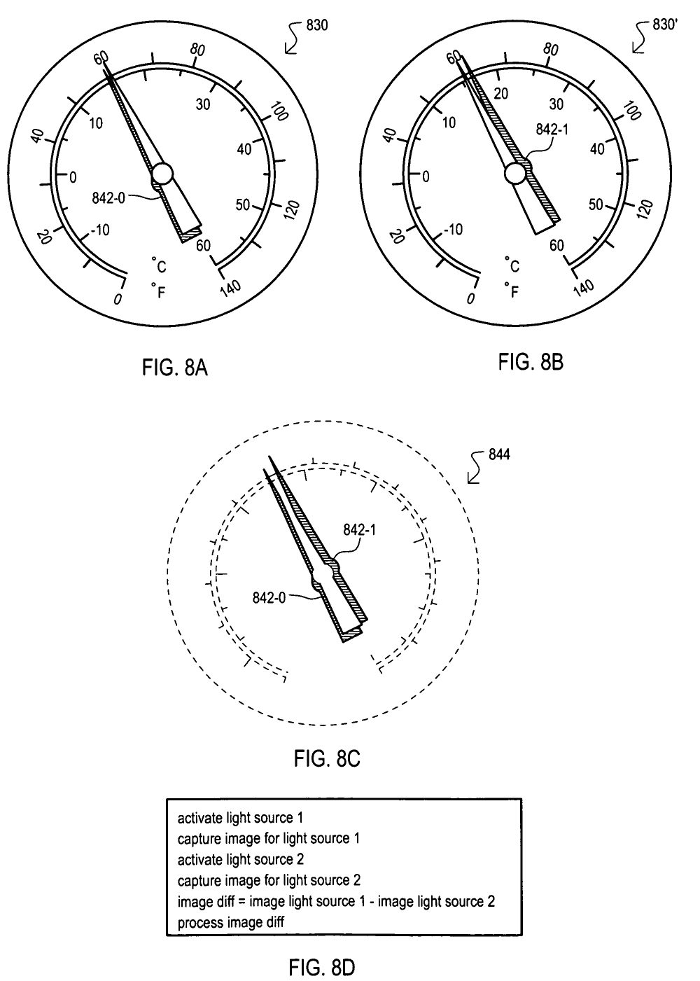

While the above embodiments have shown arrangements by which glare from illumination sources may be removed, alternate may use different acquisition conditions to arrive at other or additional results. One such arrangement is shown in FIGS. 8A to 8D. The arrangement of FIGS. 8A to 8D may be performed by a device like that of FIG. 4A, thus references to device 400 will be made in this description.

Referring now to FIG. 8A, a representation of a first image 830 is shown that may be acquired by image sensor 804 with a first light source (e.g., 406-0) is enabled and a second light source (e.g., 406-1) is disabled. Image 830 may include a first shadow 842-0 created by a feature of target object 412 (in this example a needle).

Referring now to FIG. 8B, a representation of a second image 830′ is shown that may be acquired by image sensor 804 with a second light source (e.g., 406-1) enabled and first light source (e.g., 406-0) is disabled. Image 830′ may include a second shadow 842-1 created by the same feature of target object 412 (i.e., needle).

One image (e.g., 830′) may be subtracted from the other image (e.g., 830) to create a difference image. A representation of such a difference image is shown in FIG. 8C as 844. As shown by FIG. 8C, difference image 844 may provide position information for a feature of the target object.

Referring to FIG. 8D, another embodiment is shown in a diagram. FIG. 8D may show a method according to an embodiment. Alternatively, FIG. 8D may represent a pseudocode version of instructions executable by a control section, like that shown as 208 in FIG. 2.

As shown in FIG. 8D, a first light source (light source 1) may be activated. Such a step may create a first type shadow for one or more features of a target object. An image may be captured under such conditions. A second light source (light source 2) may then be activated. Such a step may create second type shadows for the feature(s) of the target object. A difference image (image diff) may be created by subtracting one image from the other. Such a difference image may then be processed.

In this way, a device may have two different image acquisition operations to acquire two different images having different shadows. Such images may be subtracted from one another to derive information (e.g., three dimensional characteristics) of the imaged target.

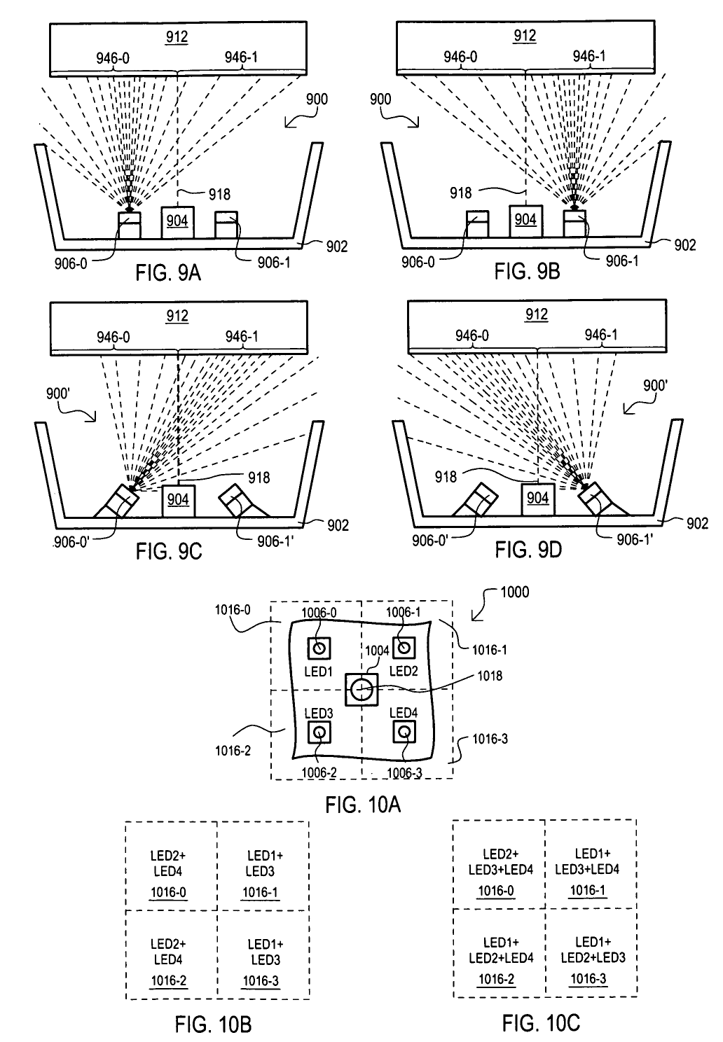

Referring to FIGS. 9A to 9D another embodiment will be described in a series of diagrams. FIGS. 9A and 9B are diagrams showing a device 900 that may include some or all of the items as device 100 of FIG. 1, thus like features are shown with the same reference characters but with the first digit being a “9” instead of a “1”. In one arrangement, device 900 may be one version of that shown in FIG. 1 or FIG. 2.

FIG. 9A shows how, in configurations where first light source 906-0 is directed parallel to a capture field axis 918, a greatest light intensity (indicated by closer spaced rays) may be directed to illuminated area 946-0, while lesser light intensity may be directed to illuminated area 946-1. As noted in embodiment above, illuminated area 946-0 having greater light intensity may correspond to an image region having a glare, and thus is an image portion that is discarded or ignored.

Similarly, FIG. 9B shows how, in configurations where second light source 906-1 is directed parallel to a capture field axis 918, a greatest light intensity (indicated by closer spaced rays) may be directed to illuminated area 946-1, while lesser light intensity may be directed to illuminated area 946-0. Illuminated area 946-1 having greater second light source intensity may be a region that is not included in a finally processed image, as it may contain glare.

FIG. 9C shows an arrangement and device like that of FIG. 9A, however, a first light source 906-0′ may be angled with respect to capture field axis 918 to direct greater light intensity to illuminated area 946-1. Similarly, second light source 906-1′ may also be angled with respect to capture field axis 918 to direct greater light intensity to illuminated area 946-0. In this way, image portions acquired in an operation may receive greater light intensity than the embodiment shown in FIGS. 9A and 9B.

It is noted that an angled light source arrangement like that of FIGS. 9C and 9D may also reduce or eliminate hot spots in an image, as a reflection from the light sources may be directed outside of an image sensor 904 capture field.

In this way, a device may have an image sensor that may acquire two different image portions under different acquisition conditions, including angled light sources.

Referring to FIGS. 10A to 10D, a devices and methods according to another embodiment are shown in a series of diagrams. The embodiments show a device having more than two light sources, where different combinations of light sources are activated when acquiring different portions of an image.

Referring to FIG. 10A, a device 1000 is shown in a top plan view. A device 1000 may include some or all of the items as device 100 of FIG. 1, thus like features are shown with the same reference characters but with the leading digits being a “10” instead of a “1”. In one arrangement, device 1000 may be one version of that shown in FIG. 1 or FIG. 2.

A device 1000 may include an image sensor 1004 around which may be situated with more than two light sources (in this case four light sources (1006-0 to 1006-3). In one particular embodiment, such light sources may be LEDs (LED1 to LED4). Superimposed over device 1000 are dashed lines representing an image capture region divided into image capture sectors 1016-0 to 1016-3. In one particular embodiment, light sources 1006-0, 1006-1, 1006-3, 1006-4 may create hot spots in image capture sectors 1016-0, 1016-1, 1016-3, 1016-4, respectively.

Referring to FIG. 10B, one example of an image capture operation is shown in a diagram. FIG. 10B shows image capture sectors 1016-0, 1016-1, 1016-3, 1016-4, and in addition, identifies which light sources may be activated to acquire image data for these image capture sectors. Thus, in the embodiment of FIG. 10B, when image data is captured for sector 1016-0, light sources 1006-1 and 1006-3 (LED2 and LED4) may be activated, while light sources 1006-0 and 1006-2 (LED1 and LED3) are deactivated. Image data may be captured for each different sector according to such varying lighting conditions. Such image data may then be combined to create a “stitched” image (in this embodiment four different sections) for image processing.

Referring to FIG. 10C, another example of an image capture operation is shown in a diagram. FIG. 1C shows a similar arrangement as that shown in FIG. 10B. However, in the embodiment of FIG. 10B, three light sources may be activated, while one is deactivated in the acquisition of data for an image capture sectors (1016-0, 1016-1, 1016-3, 1016-4). Thus, in the embodiment of FIG. 10BC when image data is captured for sector 1016-0, light sources 1006-1, 1006-2 and 1006-3 (LED2, LED3 and LED4) may be activated, while light source 1006-0 (LED1) is deactivated. Image data may be captured for each different sector according to such varying lighting conditions, and such sectors may then be combined to form an overall image for image processing.

Activation of multiple different light sources in the acquisition of different sectors can reduce undesirable shadow effects, for objects having three dimensional filters, as there is simultaneous illumination from multiple angles.

In this way, a device may capture three or more different portions of an image, by activating three or more different lighting sources in different combinations. Such different portions may be combined to create a single image.

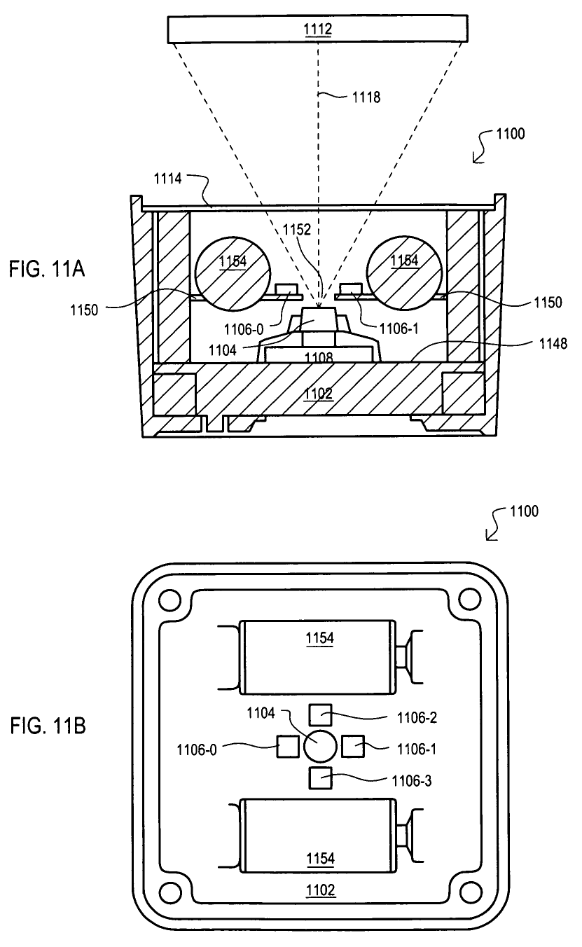

Referring now to FIGS. 11A and 11B, a device according to yet another embodiment is shown in a series of views, and designated by the general reference character 1100. A device 1100 may include some or all of the items as device 100 of FIG. 1, thus like features are shown with the same reference characters but with the leading digits being an “11” instead of a “1”. In one arrangement, device 1100 may be one version of that shown in FIG. 1 or FIG. 2. FIG. 11A is a side cross sectional view and FIG. 11B is a top plan view.

Referring to FIG. 11A, in the embodiment shown, a structure 1102 may be an enclosure having an opening covered by transparent window structure 1114. Within structure 1102, an image sensor 1104 may be attached to a first surface 1148, while light sources 1106-0 to 1106-3 may be formed on a second surface 1150 disposed over (in the direction of an intended target object) the first surface 1148. Second surface 1150 may have an opening 1152 formed therein, through which image sensor 1104 may capture image data. Electrical connections may exist between light sources 1106-0 to 1106-3, image sensor 1104 and control section 1108. In the particular embodiment shown, a device 1100 may also include batteries 1154 as a power source.

Such an arrangement may place light sources (1106-0 to 1106-3) at a different level within the space enclosed by structure 1104 in a “mezzanine” fashion. This may result in light sources (1106-0 to 1106-3) that are closer to a target object, for greater illumination.

While FIGS. 11A and 11B show a device 1100 with four light sources, alternate embodiments may include fewer or greater numbers of light sources, as well as different light source positioning. Further, light sources may be angled as in the case of the embodiment of FIGS. 9C and 9D.

In this way, a device may have an image sensor with multiple light sources for illuminating a target object positioned on a different level than the image sensor.

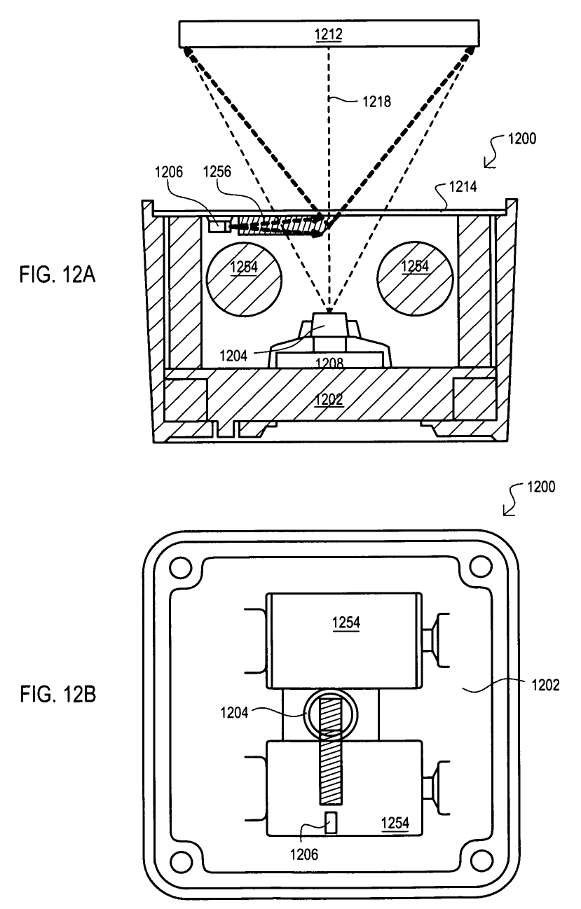

Referring now to FIGS. 12A and 12B, a device according to yet another embodiment is shown in a series of views, and designated by the general reference character 1200. A device 1200 may include some or all of the items as device 1100 of FIG. 11, thus like features are shown with the same reference characters but with the leading digits being a “12” instead of an “11”.

Referring to FIG. 12A, a device 1200 may differ from that of FIG. 11A in that a light source may be guided to direct illumination in the direction of a capture field axis 1218 of image sensor 1204. In the embodiment shown, a device 1200 may include a light source 1206 and a light “pipe” 1256. A light source 1206 may direct light to a light pipe 1256, and not necessarily at a target object. More particularly, a light source 1206 may not even directly illuminate a target object. However, a light pipe 1256 may guide light emitted from light source 1206 at a target 1212. In the embodiment of FIG. 12A, light pipe 1256 direct light at target 1212 along axis 1218. A light pipe 1256 may include a refractive or reflective surface for directing light received from light source 1206. In the very particular embodiment of FIG. 12A, a light pipe 1256 may receive light at one end, and include a reflective surface at the other end that directs light at object 1212. In one embodiment, a light pipe 1256 may be transparent, so as to not obscure acquisition of image data from object 1212. While a reflective surface at the end of light pipe 1256 may obscure a center portion of image data, in many types of objects (e.g., radial gauges), such a central portion may not be included or may not be critical in determining a gauge reading.

Directing light along axis 1218 can eliminate undesirable shadows for objects having three dimensional features as an image sensor and light source are along a same axis and have similar fields of view. This can lead to more accurate image processing.

In this way, a device may have a light source positioned out of view of an image sensor, and not oriented to direct light at a target object. A light guiding structure may direct light at the target object to provide illumination along a capture field axis of the image sensor.

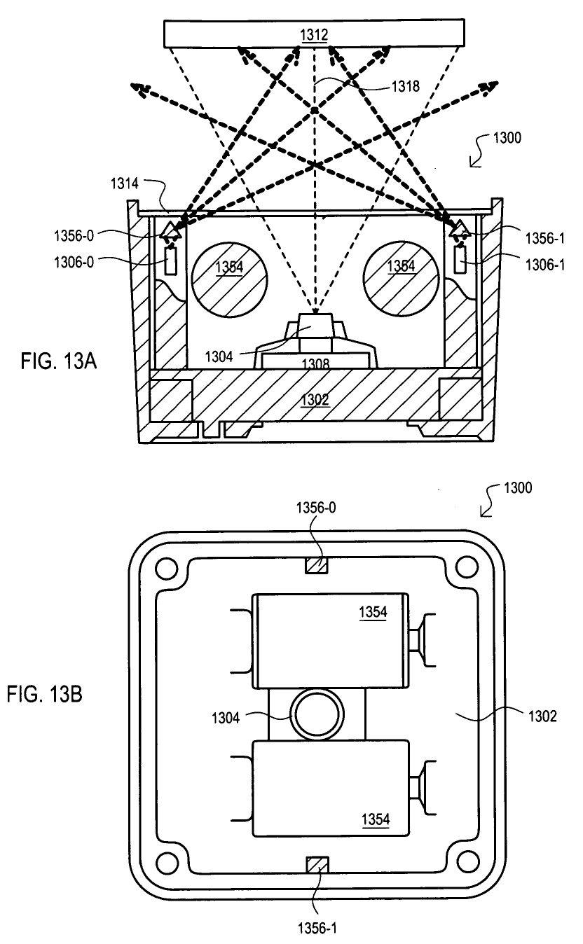

Referring now to FIGS. 13A and 13B, a device according to yet another embodiment is shown in a series of views, and designated by the general reference character 1300. A device 1300 may include some or all of the items as device 1100 of FIG. 11, thus like features are shown with the same reference characters but with the leading digits being “13” instead of an “11”. In one arrangement, device 1300 may be one version of that shown in FIG. 1 or FIG. 2. FIG. 13A is a side cross sectional view and FIG. 13B is a top plan view.

Like FIG. 12A, device 1300 of FIG. 13A may include a light source directed by light pipes. However, device 1300 includes two light sources 1306-0 and 1306-1 with corresponding light pipes 1356-0 and 1356-1, respectively. Light sources (1306-0 and 1306-1) may be positioned on sides of structure 1302, and light pipes (1356-0 and 1356-1) may project light from sides of structure toward object 1312. An embodiment like that of FIG. 12A and 12B may also reduce or eliminate hot spots in an image, as a reflection from the light emitted from light pipes may directed outside of an image sensor 1304 capture field.

In this way, a device may have multiple light sources positioned out of view of an image sensor. Light guiding structures may direct light at the target object to provide illumination for an image sensor.

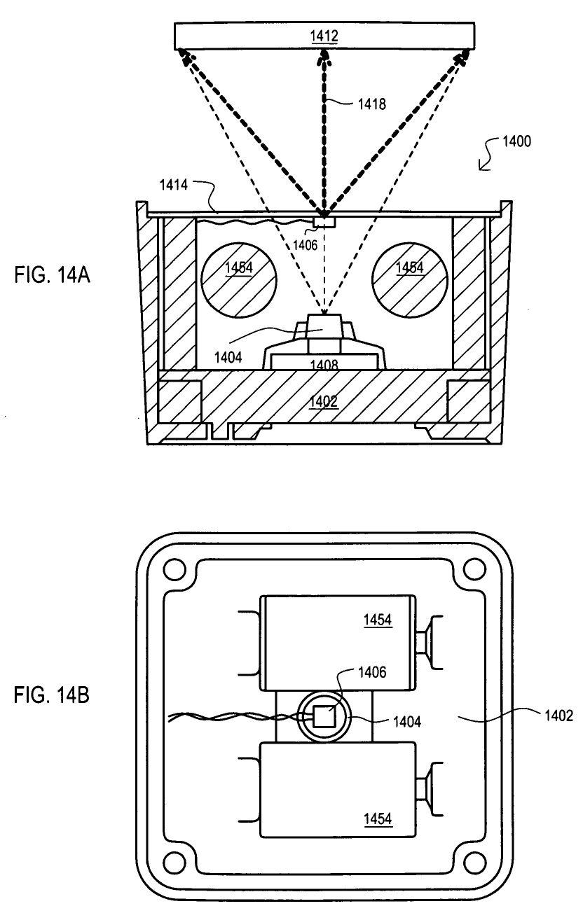

Referring now to FIGS. 14A and 14B, a device according to yet another embodiment is shown in a series of views, and designated by the general reference character 1400. A device 1400 may include some or all of the items as device 1100 of FIG. 11, thus like features are shown with the same reference characters but with the leading digits being “14” instead of an “11”.

Referring to FIG. 14A, a device 1400 may differ from that of FIG. 11A in that a light source 1406 may be situated between an image sensor 1404 and a target object 1412. In the particular embodiment of FIG. 14A, a light source 1406 may be positioned along a capture field axis 1418. Such an arrangement may place a light source 1406 in closer proximity to a target object 1412 to provide greater and/or more uniform illumination of a target 1412, as compared to embodiments that place a light source 1406 at about a same level as an image sensor 1406. While a light source 1406 may obscure a center portion of image data, as noted previously in many types of objects (e.g., radial gauges), such a central portion may not be included in determining a gauge reading.

In this way, a device may have a light source positioned between an image sensor and a target object.

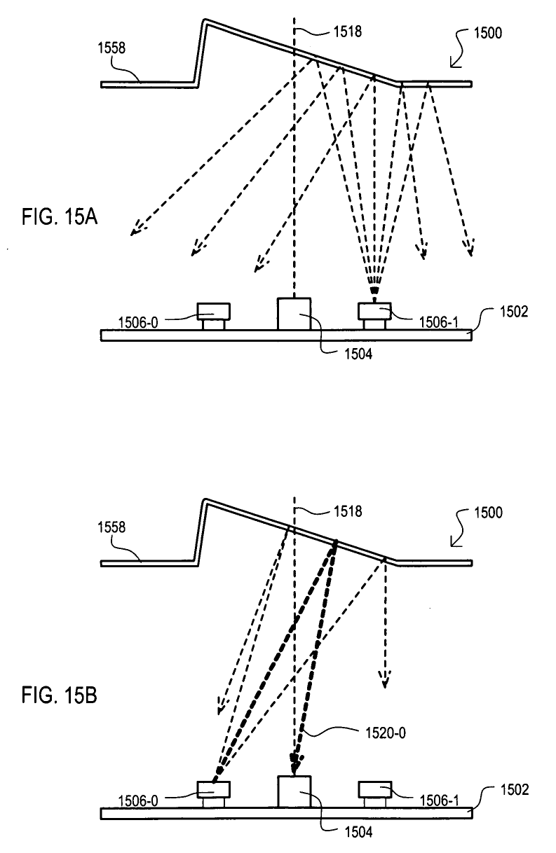

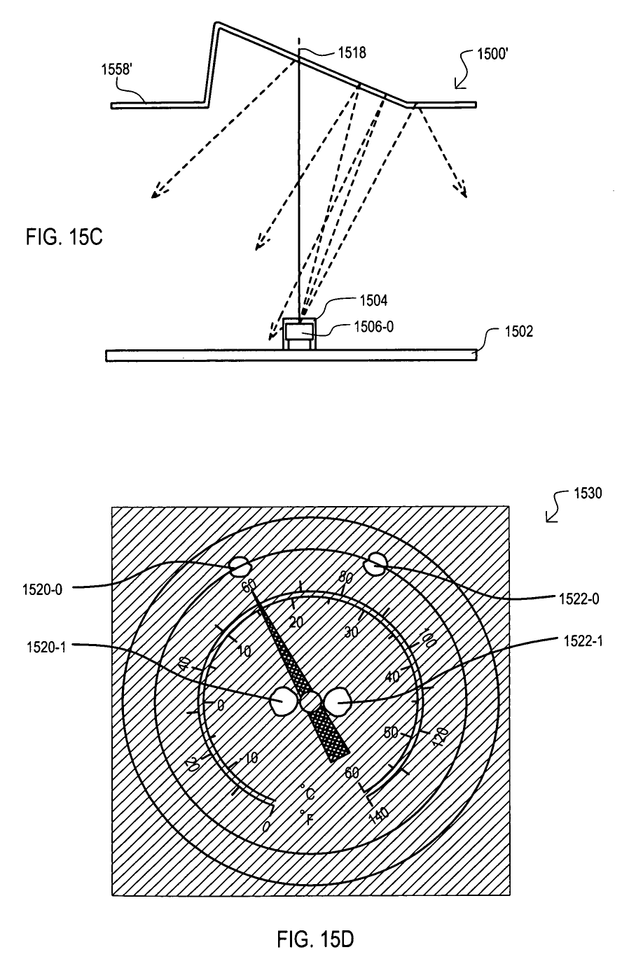

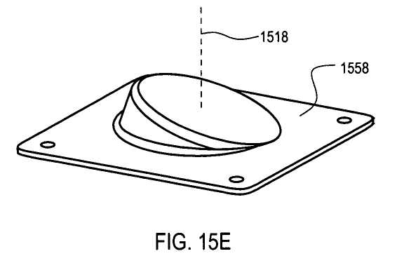

Referring to FIGS. 15A to 15E, a device and method according to further embodiments are shown in a series of diagrams. FIGS. 15A to 15E show embodiments that may include a transparent window having an angled surface disposed between a light source and a target image. Such an angled window may angle reflections of light sources away from image sensors to reduce unwanted glare effects (e.g. hot spots).

FIGS. 15A and 15B are diagrams that show aspects of a device 1500 and corresponding operations according to embodiments. A device 1500 may include some or all of the items as device 100 of FIG. 1, thus like features are shown with the same reference characters but with the first digits being “15” instead of a “1”. In one arrangement, device 1500 may be one version of that shown in FIG. 1 or FIG. 2.

FIGS. 15A and 15B may differ from FIG. 1 in that they may include an angled window structure 1558. An angled window structure 1558 may be a structure having a transparent portion at a non-perpendicular angle to the direction of light sources 1506-0 and 1506-1. In the embodiment of FIGS. 15A and 15B, light sources (1506-0 and 1506-1) may be aligned with one another along the direction of the window angle. That is, the distance between the light sources (1506-0 and 1506-1) and the angled surface varies.

As shown in FIG. 15A, due to the angled surface of angled window structure 1558, light reflecting off of angled window structure 1558 from light source 1506-1 may be directed away from image sensor 1504, thus placing any hot spots out of, or at an edge of an acquired image.

As shown in FIG. 15B, when light sources (1506-0 and 1506-1) are aligned along the direction of a window angle, while one light source (1506-1) may have its light reflected away from an image sensor 1504, another light source (e.g., 1506-0) may still create a hot spot (represented by arrow 1520-0).

FIG. 15C shows further embodiments having an angled window. FIG. 15C may differ from the configuration shown in FIGS. 15A and 15B in that light sources 1506-0 and 1506-1 (not shown in the view) may be aligned with one another in a direction perpendicular to the direction of the window angle. That is, the distance between the light sources (1506-0 and 1506-1) and the angled surface does not vary. In such an arrangement, light from both light sources (1506-0 and 1506-1) may be reflected away from image sensor 1504, thus removing or reducing hot spots created by a transparent window situated between an image sensor and a target object (now shown).

Referring to FIG. 15D, a representation of an image 1530 that may be captured by a device like that of FIG. 15C is shown in a diagram. In the example shown, an image 1530 may include hot spots 1520-0 and 1522-0 created by reflections off of an angled transparent window. As shown, such hot spots (1520-0 and 1522-0) may be angled to the periphery of the image 1530, and thus may not adversely affect subsequent processing of the acquired image. In the particular example of FIG. 15D, hot spots 1520-1 and 1522-1 created by reflections off of a target object may remain.

Referring to FIG. 15E, one very particular embodiment of an angled window 1558 is shown in a perspective view. In very particular arrangements, angled window 1558 of FIG. 15D may be mounted in devices like those shown in FIGS. 11A and 11B.

In this way, a device may include a transparent angled window between an image sensor and a target object that may reflect light from light sources away from image sensor, to thereby reduce unwanted glare effects.

While embodiments above have shown arrangements that include but one image sensor. Other embodiments can include multiple image sensors having different fields of capture to eliminate glare. As but one example, one image sensor can capture an image having a hot spot in a first image portion, while a second image sensor can capture the same image with the first portion not having the hot spot. The second image sensor can be spaced apart from the first camera and/or angled with respect to the first image sensor. In this way there can be a tradeoff between the number of light sources versus the number of image sensors.

It should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

It is also understood that the embodiments of the invention may be practiced in the absence of an element and/or step not specifically disclosed. That is, an inventive feature of the invention may be elimination of an element.

Accordingly, while the various aspects of the particular embodiments set forth herein have been described in detail, the present invention could be subject to various changes, substitutions, and alterations without departing from the spirit and scope of the invention.

What is claimed is:

1. A method of capturing a digital image of an object, comprising:
capturing at least a first portion digital image with an image sensor while the object having an at least partially light reflective surface is illuminated with a first light source;
capturing at least a second portion digital image with the image sensor while the object is illuminated with a second light source;
combining at least the first portion digital image and second portion digital image to form a stitched digital image larger than the first portion digital image.

2. The method of claim 1, wherein:
capturing at least the first portion digital image includes capturing a first digital image having the first portion digital image and a first reflection portion having a first light source reflection;
capturing at least the second portion digital image includes capturing a second digital image having the second portion digital image and a second reflection portion having a second light source reflection; and
the stitched digital image does not include the first reflection portion or the second reflection portion.

3. The method of claim 1, wherein:
capturing at least the first portion digital image includes enabling the first light source while the image sensor captures the first portion digital image; and
capturing at least the second portion digital image includes disabling the first light source and enabling the second light source as the image sensor transitions from acquiring the first portion digital image to acquiring the second portion digital image.

4. The method of claim 1, further including:
capturing at least the first portion digital image includes capturing a first digital image having the first portion and a first reflection portion with pixels having a first light source reflection;
determining reflection pixel locations having the first light source reflection in the first digital image;
capturing the second portion digital image includes capturing pixels for the reflection pixel locations with the first light source disabled; and
combining at least the first portion digital image and second portion digital image includes replacing pixels at the reflection pixel locations in the first digital image with the pixels for the reflection pixel locations with the first light source disabled.

5. The method of claim 1, further including:
the first light source provides illumination of a first color spectrum;
the second light source provides illumination of a second color spectrum;
capturing at least the first portion digital image includes filtering out the second color spectrum from the first portion digital image;
capturing at least the second portion digital image includes filtering out the first color spectrum from the second portion digital image; and
converting the first portion digital image and second portion digital image to a common intensity image format prior to combining the first portion digital image and second portion digital image.

6. The method of claim 1, wherein:
capturing at least the first portion digital image includes capturing a first digital image that includes a first shadow of the object created by the first light source;
capturing at least the second portion digital image includes capturing a second digital image having a second shadow of the object created by the second light source; and
subtracting one of the digital images from the other to create a subtracted digital image that includes differences between the first shadow and second shadow.

7. The method of claim 1, further including:
capturing at least the first portion digital image includes capturing the first portion digital image with the second light source not illuminating the object and at least a third light source illuminating the object;
capturing at least the second portion digital image includes capturing the second portion digital image with the first light source not illuminating the object and the third light source illuminating the object;
capturing at least a third portion digital image with the image sensor while the object is illuminated with the third light source and the first light source not illuminating the object; and
combining at least the first portion digital image and second portion digital image includes combining the first portion digital image, second portion digital image and third portion digital image.

8. A device for illuminating and capturing an image of an object, comprising:
a first light source mounted to structure;
a second light source mounted to the structure;
an image sensor disposed adjacent to the first and second light sources and mounted to the structure, the image sensor capturing at least two different partial images of a target area, the partial images being captured under different acquisition conditions; and
a controller section that includes at least a memory that stores the at least two partial images to form a larger image.

9. The device of claim 8, wherein:
the controller section is further coupled to activate and deactivate the first light source and second light source; and
the image sensor generates image data for a first partial image while the first light source is activated and the second light source is deactivated, and generates image data for a second partial image while the second light source is activated and the first light source is deactivated, wherein the different acquisition conditions include the activation of different light sources.

10. The device of claim 9, wherein:
the image sensor captures a first image of the target area that includes the first partial image with the first light source enabled and second light source disabled, and captures a second image of the target area that includes the second partial image with the second light source enabled and first light source disabled.

11. The device of claim 9, wherein:
the controller section, in a first time period, activates the light source, while the second light source is deactivated, and in a second time period activates the second light source while the first light source is deactivated; and
the image sensor captures an image that includes the first partial image and second partial image in a continuous capture operation, the first partial image being acquired in the first time period, the second partial image being acquired in the second time period.

12. The device of claim 11, wherein:
the first partial image comprises a first contiguous group of pixel columns, and
the second partial image comprises a second contiguous group of pixel columns.

13. The device of claim 8, wherein:
the image sensor captures the first partial image with a first set of imaging cells configured to filter out at least a first predetermined color, and captures the second partial image with a second set of imaging cells configured to filter out at least a second predetermined color, wherein the different acquisition conditions include the filtering of different predetermined colors for different partial images.

14. The device of claim 8, wherein:
the structure includes a gauge mount for attaching to an analog gauge.

15. The device of claim 8, wherein:
the structure includes
a first surface on which the image sensor is mounted,
a mounting surface formed between the image sensor and the target area having a hole through which the image sensor acquires an image, and
the first light source and second light source are mounted on the mounting surface adjacent to the hole.

16. The device of claim 8, further including:
at least a third light source;
the controller section is further coupled to activate and deactivate the first light source, second light source, and third light source; and
the image sensor generates image data for a first partial image while the first and third light sources are activated and the second light source is deactivated, generates image data for a second partial image while the second light source is activated and the first light source is deactivated, and generated image data for a third partial image while the third light source is disabled in the second light source is enabled.

17. The device of claim 8, wherein:
a first light source and second light source are angled with respect to a center axis of the image sensor field of capture.

18. The device of claim 8, wherein:
the first light source includes a first light emitter and a first light pipe that guides light from the first light emitter to a target object location, and
the second light source includes a second light emitter and a second light pipe that guides light from the second light emitter to the target object location.

19. The system of claim 8, wherein:
the structure includes a transparent window structure having a surface not perpendicular to a center axis of the image sensor field of capture.

20. A device for illuminating and capturing an image of an object, comprising:
an image sensor mounted to a structure surface having a field of capture with a central axis that extends in a first direction; and
at least one light source separated from the image sensor in the first direction that provides illumination that is directed along the central axis of the field of capture.

21. The device of claim 20, further including:
a transparent window structure formed apart from the image sensor in the first direction; and
the at least one light source is attached to the transparent window structure.

22. The device of claim 20, wherein:
that at least one light source includes a light emitter and a first light pipe that receives light from the light emitter and directs the received light along the central axis of the field of capture.
